(19) United States
(12) Patent Application Publication
(10) Pub. No.: US 2014/0284228 A1
(43) Pub. Date: Sep. 25, 2014

(54) HOUSING CAPABLE OF SUPPORTING TABLET COMPUTER IN PREDETERMINED ORIENTATIONS

(71) Applicant: Shih- Hsun Chiou, Taipei Hsien (TW)

(72) Inventor: Shih- Hsun Chiou, Taipei Hsien (TW)

(21) Appl. No.: 13/847,468

(22) Filed: Mar. 19, 2013

(51) Int. Cl. G06F 1/16

(52) U.S. Cl. CPC G06F 1/1626; G06F 1/1632
USPC 206/45.23; 206/320

(57) ABSTRACT

A housing capable of supporting a tablet computer in some predetermined orientations includes a lower casing for protecting a tablet computer; an upper cover rotatably connected to the lower casing for protecting the screen of the tablet computer from damage; the upper cover being formed with a plurality of line areas so that the upper cover is foldable along the foldable line areas between different sections. The foldable line areas includes a Y shape foldable section and three parallel foldable line areas. Furthermore, in another case, two further foldable line areas extend from a connecting point of the Y shape foldable section to two corners of the upper cover. The upper casing is foldable along the foldable lines so as to be formed as a supporter of the lower casing for supporting a tablet computer therein.

The present invention is a continuation in part (CIP) of U.S. patent application Ser. No. 13/186,472 and U.S. patent application Ser. No. 13/280,329 which are assigned to the applicant of the present invention and therefore, the contents of the U.S. patent application Ser. Nos. 13/186,472 and 13/280,329 are incorporated into the present invention as a part of the present invention.

### FIELD OF THE INVENTION

The present invention relates to tablet computers, and in particular to a housing capable of supporting a tablet computer in some predetermined orientations, which provides an upper cover being used as a cover and a supporter so that a tablet computer therein can be well protected and be supported in some predetermined orientations.

### BACKGROUND OF THE INVENTION

Tablet computers are a main trend in applications of computers. The percentage of tablet computers over the prior computers is increased gradually. iPad Smart Covers are covers for protecting screens of iPads, but it only cover a front side of the iPad. Backsides of the iPads are not covered by iPad Smart Covers. However in many applications of iPads, it is necessary to make the iPad stand at a desired orientation for getting a preferred view angle to viewers. Generally, the user finds a supporter to support the tablet computer or take it at hand. However this is inconvenient for users. Although smart covers have a function of supporting an iPad to stand on a table, slopes of an iPad on a table are limited to some predetermined ones and thus supporting function to the smart covers is limited .

Furthermore, if an iPad is not used, it is necessary to store the iPad and other documents used with the iPad. As a result, the user must prepare another bag for receiving the iPad and others. It is inconvenient for users.

Thus, there is an eager demand for a novel design which can resolve the prior art defects.

### SUMMARY OF THE INVENTION

The object of the present invention is to provide a tablet computer housing capable of supporting a tablet computer in some predetermined orientations. The present invention is not only used for supporting tablet computer, but also it can be used to support the computer in different orientations. Thus, the user is not necessary to prepare another supporter for supporting the tablet computers. Therefore, the function of the housing for tablet computer is enhanced and the user will feel convenient.

To achieve above object, the present invention provides a tablet computer housing capable of supporting a tablet computer in some predetermined orientations, comprising: a lower casing for protecting a tablet computer; an upper cover having an approximate rectangular shape and having an upper side pivotally connected to a lower side of the lower casing for protecting a screen of the tablet computer; the upper cover being formed with at least one foldable line areas; each foldable line area having a predetermined width and having a weak structure weaker than other area of the upper cover; the upper cover being formed with a Y shape foldable section and at least two approximate parallel line areas; the Y shape foldable section being formed by three foldable line areas which are connected at a connecting point; each distal end of two foldable line areas of the Y shape foldable section reaching to two upper corners of the upper cover at the upper side thereof and adjacent to a lower side of the lower casing; another foldable line area of the Y shape foldable section reaching to an approximate middle point of a lower side of the upper cover; one foldable line area of the approximate parallel line areas passing through the connecting point of the Y shape foldable section; and wherein the upper cover is used as a cover and a supporter; the upper cover rotates along the lower casing; the upper cover is foldable along the foldable line areas so as to be formed as a supporter of the lower casing for supporting the tablet computer therein.

Furthermore, the tablet computer housing further comprises two inclined foldable line areas; and the two inclined foldable line areas extending from the connecting point to two lower corners of the lower side of the upper cover.

### BRIEF DESCRIPTION OF THE DRAWINGS

FIG. 1 shows a perspective view about the first embodiment of the present invention.

FIG. 2 shows that a tablet computer is placed into the casing.

FIG. 3 shows that according to the present invention, the upper cover covers the lower casing.

FIG. 4 shows the application of first embodiment of the present invention.

FIG. 5 shows another application of first embodiment of the present invention.

FIG. 6 shows a perspective view about the second embodiment of the present invention.

FIG. 7A shows the application of the second embodiment of the present invention.

FIG. 7B shows another application of the second embodiment of the present invention.

FIG. 8 shows a further application of the second embodiment of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

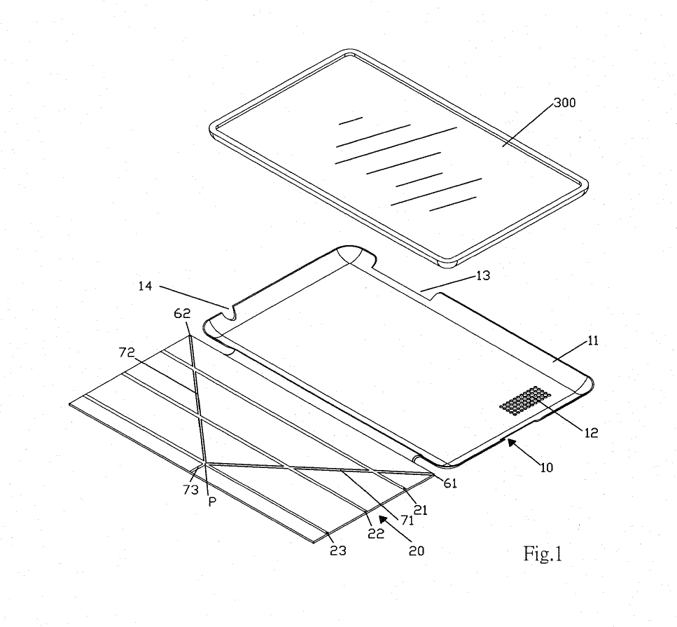

The present invention will be described herein with reference to FIGS. 1 to 8.

Referring to FIG. 1, a lower casing 10 serves for protecting a tablet computer. A periphery of the lower casing 10 is formed with a frame 11 for enclosing a tablet computer completely so as to prevent damages from external sources, powders, evaporations, and avoid damages due to collisions. The frame 11 and lower casing 10 are formed with a plurality of holes, one hole 14 serves for exposing a USB slot, one hole 12 for sound transmission, and other holes 13 for heat dissipation and other functions.

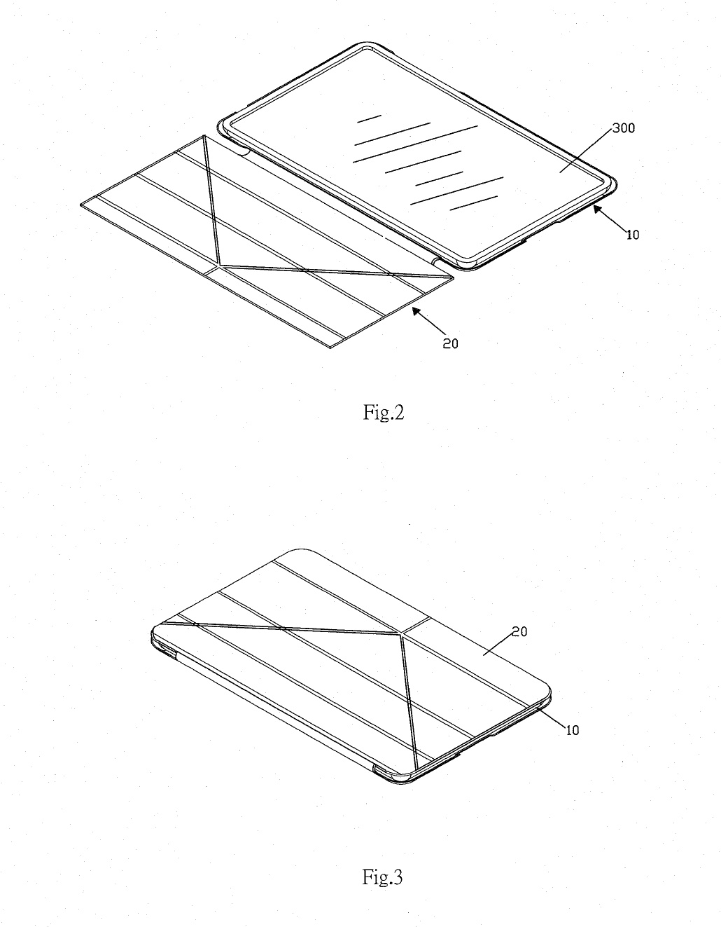

FIG. 2 shows that a tablet computer 300 is placed on the lower casing 10. The lower casing 100 serves to enclose the tablet computer.

An upper cover 20 has an approximate rectangular shape and has an upper side pivotally connected to a lower side of the lower casing 10 for protecting the screen of the tablet computer from damages. The upper cover 20 is formed with at least one foldable line areas 21. Each foldable line area has a predetermined width and has a weak structure weaker than other area of the upper cover 20. In the present invention, the upper cover 20 can be attached to the lower casing 10 by magnets embedded in the lower casing 10 or in the upper cover 20.

The upper cover 20 includes two kinds of foldable line areas. For the first kind of foldable line areas traces as illustrated in FIG. 1(A), the upper cover 20 is formed with a Y shape foldable section and three approximate parallel line areas 21, 22, and 23. The Y shape foldable section is formed by three foldable line areas 71, 72 and 73 which are connected at a connecting point P. Two ends of the foldable line areas 71, 72 reach to two upper corners 61, 62 of the upper cover 20 at the upper side thereof and adjacent to the lower side of the lower casing 10. Another foldable line area 73 of the Y shape foldable section reaches to an approximate middle point of a lower side of the upper cover 20. One of the three approximate parallel line areas 23 passes through the connecting point P of the Y shape foldable section.

FIG. 3 shows that the upper cover 20 can cover upon the lower casing 10 for receiving a tablet computer therein.

The present invention provides two ways for folding the upper cover along the foldable line areas of the upper cover 20. FIG. 4 shows the first folding way, the two foldable line areas 71, 72 are folded backwards and the two oblongs confined by the foldable line area 23 and the foldable line area 73 are overlapped to one another so that the upper cover 20 is formed as a steady seat to support the lower casing 10 as illustrated in FIG. 4 of the present invention.

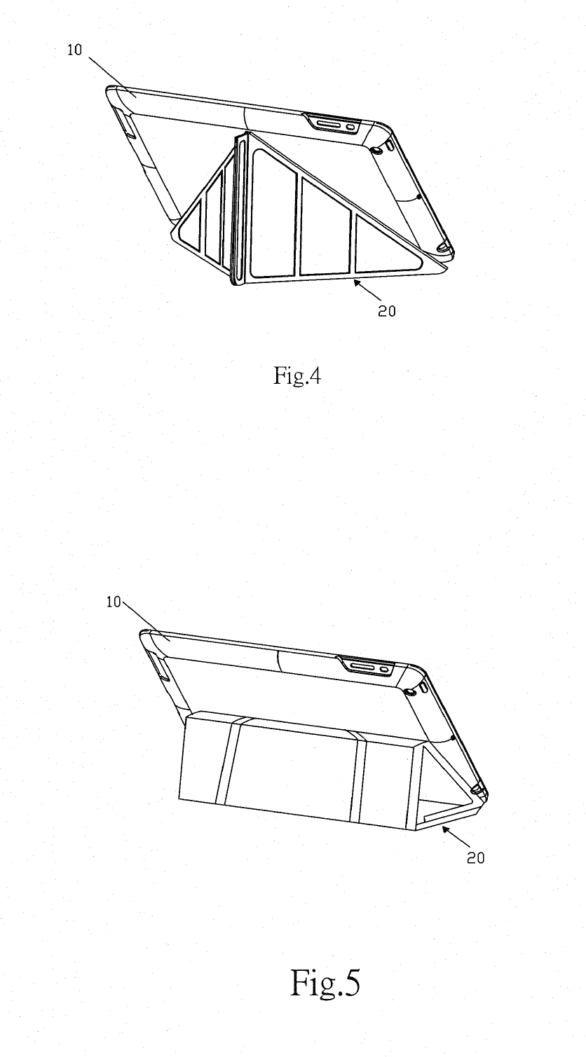

FIG. 5 shows the second folding way, the upper cover 2 is folded along the foldable line areas 21, 22 and 23 to formed as a triangle seat and then the seat is adhered to a backside of the lower casing 10 to support the table computer 300 (not shown in FIG. 5) thereupon.

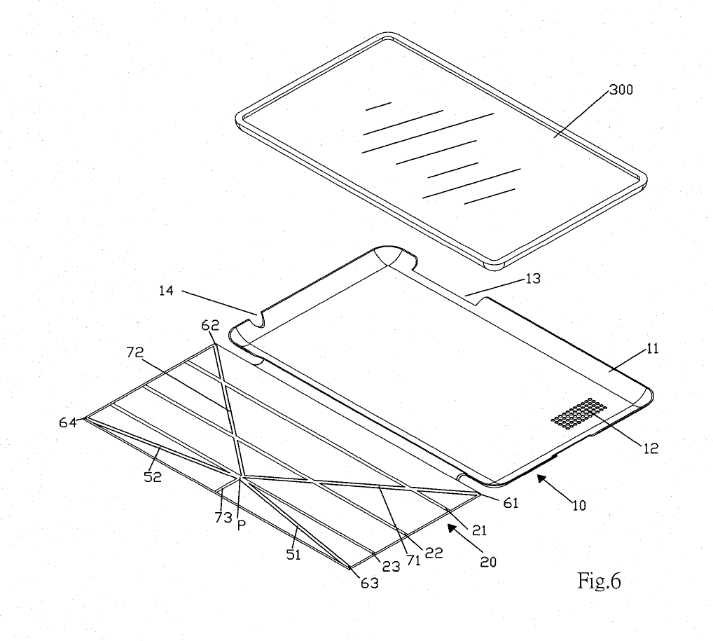

FIGS. 6 to 8 show the second embodiment of the present invention. In this embodiment, all elements indicated with the same numerals as those shown in the first embodiment illustrated in FIG. 1 have the same functions and effects as those shown in the first embodiment; and thus the details of these elements will not be described herein.

Referring to FIG. 6A, in this embodiment, other than the Y shape foldable section and three foldable line areas 21, 22 and 23 as illustrated in the first embodiment, other two foldable line areas 51, 52 are contained. The two foldable line areas 51, 52 extend from the connecting point P to two lower corners 63, 64 of the lower side of the upper cover.

Each foldable line area 51, 52 has a predetermined width and has a weak structure weaker than other area of the upper cover 20.

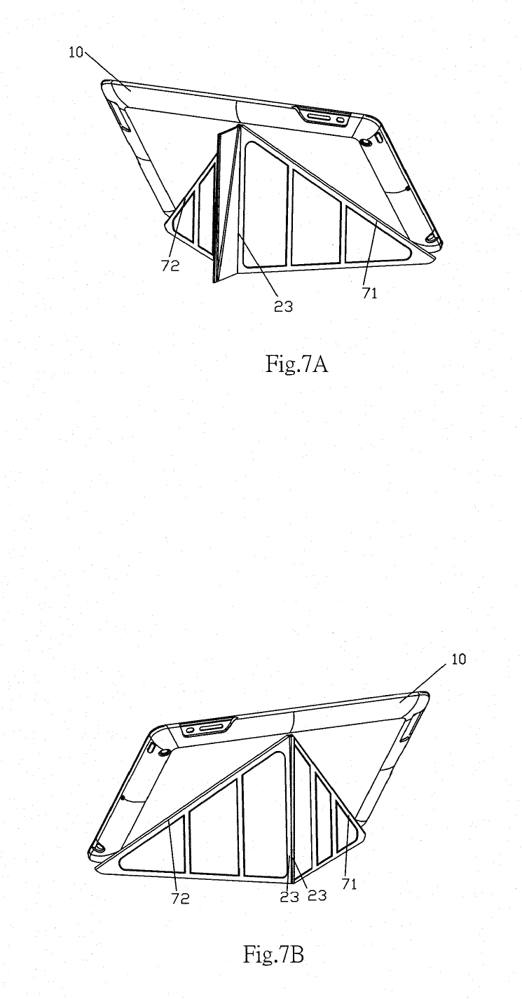

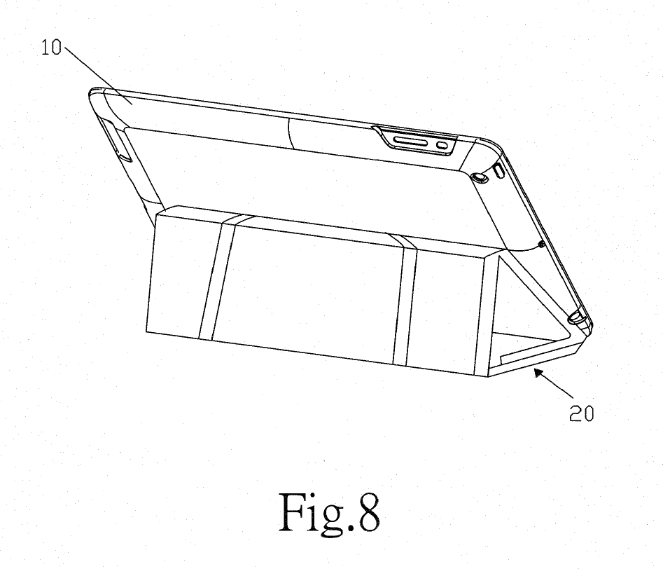

FIG. 7A shows the first folding way of the present invention based on the foldable line areas shown in FIG. 6 the present invention. FIG. 7B shows the second folding way of this embodiment based on the second embodiment of the present invention, wherein the areas between the foldable line area 23 and the lower side of the upper cover 20 are hidden in the tapered structure T shown in backside of the lower casing 10. FIG. 8 shows the third folding way of this embodiment based on the foldable line areas 21, 22 and 23 shown in FIG. 6 of the present invention.

Advantages of the present invention are that the present invention is not only used for supporting a tablet computer, but also it can be used to support the computer in different orientation. Thus, the user is not necessary to prepare another supporter. Therefore, the functions of the casing for tablet computer are enhanced and the user will feel convenient as he (or she) carries the computer.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A housing capable of supporting a tablet computer in some predetermined orientations, comprising:
a lower casing for protecting a tablet computer;
an upper cover having an approximate rectangular shape and having an upper side pivotally connected to a lower side of the lower casing for protecting a screen of the tablet computer; the upper cover being formed with at least one foldable line areas; each foldable line area having a predetermined width and being foldable along the foldable line area;
the upper cover being formed with a Y shape foldable section and at least two approximate parallel line areas; the Y shape foldable section being formed by three foldable line areas which are connected at a connecting point; each distal end of two foldable line areas of the Y shape foldable section reaching to two upper corners of the upper cover at the upper side thereof and adjacent to a lower side of the lower casing; another foldable line area of the Y shape foldable section reaching to an approximate middle point of a lower side of the upper cover; one of the at least two approximate parallel line areas passing through the connecting point of the Y shape foldable section; and
wherein the upper cover is used as a cover and a supporter; the upper cover rotates along the lower casing; the upper cover is foldable along the foldable line areas so as to be formed as a supporter of the lower casing for supporting the tablet computer therein.

2. The housing as claimed in claim 1, further comprising two inclined foldable line areas; the two inclined foldable line areas extending from the connecting point to two lower corners of the lower side of the upper cover.

3. The housing as claimed in claim 1, wherein there are three parallel foldable line areas.

4. The housing as claimed in claim 2, wherein there are three parallel foldable line areas.

5. The housing as claimed in claim 1, wherein the frame and lower casing are formed with a plurality of holes, one hole serves for exposing a USB slot, one hole for sound transmission, and other holes for heat dissipation and other functions.

6. The housing as claimed in claim 2, wherein the frame and lower casing are formed with a plurality of holes, one hole serves for exposing a USB slot, one hole for sound transmission, and other holes for heat dissipation and other functions.

7. The housing as claimed in claim 1, wherein the upper cover is attached to the lower casing by magnets embedded in the lower casing or in the upper cover.

8. The housing as claimed in claim 2, wherein the upper cover is attached to the lower casing by magnets embedded in the lower casing or in the upper cover.
